(19) United States
(12) Patent Application Publication
(10) Pub. No.: US 2014/0077499 A1
(43) Pub. Date: Mar. 20, 2014

(54) UNDERWATER ELECTRIC ROTATING DEVICE HAVING WATERPROOFING STRUCTURE AND UNDERWATER GENERATOR USING THE SAME

(71) Applicant: EEGEN CO., LTD., Gwangju (KR)

(72) Inventor: Sung Jun Joo, Seoul (KR)

(73) Assignee: EEGEN CO., LTD.

(21) Appl. No.: 13/935,017

(22) Filed: Jul. 3, 2013

Related U.S. Application Data
(63) Continuation of application No. PCT/KR2013/003221, filed on Apr. 17, 2013.

(30) Foreign Application Priority Data
Sep. 14, 2012 (KR) 10-2012-0101933

(51) Int. Cl. F03B 13/10; H02K 5/10

(52) U.S. Cl. CPC F03B 13/10; H02K 5/10
USPC 290/54; 310/87; 310/45

(57) ABSTRACT

The present invention provides an underwater electric rotating device and an underwater generator using the same. The device includes a rotating shaft, at least a portion of which is rotated in an underwater environment; a rotor which is rotated along with the rotating shaft; a stator which is provided around the rotor and rotates the rotor using electric energy or generates electric energy using rotation of the rotor; and a housing which has at least two waterproof spaces therein which are separated from each other by a partition wall formed perpendicular to the rotating shaft. In the at least two waterproof spaces, a waterproof space that is disposed at the outermost position based on a waterproof space having the rotor and the stator therein is filled with a material that is higher in specific gravity or viscosity than water at room temperature under atmospheric pressure.

### REFERENCE TO RELATED APPLICATIONS

This is a continuation of pending International Patent Application PCT/KR2013/003221 filed on Apr. 17, 2013, which designates the United States and claims priority of Korean Patent Application No. 10-2012-0101933 filed on Sep. 14, 2012, the entire contents of which are incorporated herein by reference.

### FIELD OF THE INVENTION

The present invention relates generally to underwater electric rotating devices having waterproofing structures and underwater generators using the same and, more particularly, to an underwater electric rotating device for underwater motors or underwater generators which has at least two waterproof spaces filled with materials which differ from each other in specific gravity or viscosity so that water can be prevented from permeating the device by virtue of a difference in specific gravity between the filling materials or by virtue of higher viscosity than that of water, and an underwater generator using the same.

### BACKGROUND OF THE INVENTION

Devices such as hydropower generators, underwater motors, underwater pumps, etc. are operated with water coming into direct contact therewith. Therefore, water frequently permeates the devices, and if water enters the devices, it may damage the devices, for example, causing short-circuits of electric elements, thus reducing the lifetime of the devices.

Therefore, it is very important for such underwater electric rotating devices to have a waterproofing structure and function. For this, different kinds of waterproofing structures and methods have been proposed.

Mechanical seals, oil seals, gland packing, etc. are representative examples of the conventional waterproofing structures and methods. A mechanical seal is advantageous in that wear of elements is reduced and a contact surface is limited to a seal face so that the coefficient of friction is reduced, thus reducing a loss of power, and the lifetimes of the elements are comparatively long so that it can be continuously used for a long period of time. However, there are disadvantages in that the number of elements is comparatively large and its structure is complex, whereby the initial installation cost is very high. In the case of the gland packing, the number of elements is comparatively small and its structure is simple, so that the initial installation cost is low. However, because of a relatively large contacting pressure, a loss of power resulting from contact resistance is large, and wear between elements is increased, thus reducing the lifetime of the elements. Therefore, periodical maintenance, replacement and inspection are required for all the time of use.

Hereinafter, a waterproofing method using a mechanical seal which is currently primarily used will be explained in detail. FIG. 1 illustrates a waterproofing structure of an underwater generator using a conventional mechanical seal.

A rotating shaft 15 extends out of a housing 11 through one end of the housing 11, and blades 18 are connected to the end of the rotating shaft 15. A mechanical seal 12 is provided in a junction between the housing 11 and the rotating shaft 15 to provide a waterproofing function and facilitate the rotation of the rotating shaft 15.

The mechanical seal 12 includes a rotary part 12a which is fastened to the rotating shaft 15 and is rotated along with the rotating shaft 15, and a stationary part 12b which is fastened to the housing 11. A face seal having a mechanical structure forms a contact surface which is perpendicular to the shaft. While one surface of the face seal rotates along with the rotating shaft, a sealing function of the rotary part 12a can be reliably maintained by tension of a spring or pressure of a fluid.

Although the conventional mechanical seal can provide a superior waterproofing function, the production cost is comparatively high, because of a complex mechanical structure, whereby the production cost of the underwater electric rotating device is also increased. As a result, it is difficult to use the conventional mechanical seal in underwater electric rotating devices such as underwater motors, underwater generators, etc. which are typically inexpensive.

### SUMMARY OF THE INVENTION

Accordingly, the present invention has been made keeping in mind the above problems occurring in the prior art, and an object of the present invention is to provide an underwater electric rotating device which can be operated in an underwater environment at low cost using an internal waterproofing structure.

Particularly, another object of the present invention is to solve the problems of a loss of power, short lifetime, a short maintenance and repair period, etc., which have occurred in the conventional inexpensive waterproofing structures such as gland packing, and the problem of the conventional mechanical seal that the production cost thereof is high although the mechanical seal can provide an effective waterproofing function.

A further object of the present invention is to provide an underwater generator which can be directly disposed in water so that drive force can be directly transmitted to the generator, thus enhancing the efficiency of generation, and which can provide effective generation performance even in an underwater environment of a small amount of water.

In order to accomplish the above object, in an aspect, the present invention provides an underwater electric rotating device having a waterproofing structure, including: a rotating shaft, at least a portion of which is rotated in an underwater environment; a rotor provided around a portion of an outer surface of the rotating shaft, the rotor being rotated along with the rotating shaft; a stator provided around the rotor at a position corresponding to the rotor with a predetermined distance between the rotor and the stator, the stator rotating the rotor using electric energy or generating electric energy using rotation of the rotor; and a housing having at least two waterproof spaces successively formed therein in a direction of the rotating shaft, the waterproof spaces being separated from each other by a partition wall formed perpendicular to the rotating shaft, with a through hole formed in the partition wall so that the rotating shaft is disposed in the through hole so as to be rotatable, wherein, in the waterproof spaces, a waterproof space that is disposed at an outermost position based on a waterproof space having the rotor and the stator therein is filled with a material that is higher in specific gravity or viscosity than water at room temperature under atmospheric pressure.

In an embodiment of the present invention, the waterproof spaces of the housing may include: a first waterproof space having the rotor and the stator therein; and two second waterproof spaces respectively provided on opposite ends of the first waterproof space, wherein the first waterproof space is filled with a material that is lower in specific gravity or viscosity than a material charged into the second waterproof space.

In another embodiment of the present invention, the waterproof spaces of the housing may include: a first waterproof space having the rotor and the stator therein; and a second waterproof space configured such that a first side thereof faces the first waterproof space while a second side thereof comes into contact with water, wherein the first waterproof space is filled with a material that is lower in specific gravity or viscosity than a material charged into the second waterproof space.

The material charged into the first waterproof space may be lower in specific gravity or viscosity than the water, and the material charged into the second waterproof space may be higher in specific gravity or viscosity than the water.

Furthermore, a bearing or seal may be provided in the through hole around the rotating shaft to facilitate the rotation of the rotating shaft.

The material charging into each of the waterproof spaces may comprise a liquid containing powder or a gel-type liquid.

In addition, an end of the rotating shaft may be disposed in water, and a plurality of blades may be radially provided around the end of the rotating shaft so that the rotating shaft is rotated by flow of water.

The rotating shaft may comprise a cylindrical pipe structure having a hollow inner space through which water flows, and a plurality of blades may protrude from an inner surface of the rotating shaft towards the center axis thereof so that the rotating shaft is rotated by water flowing through the hollow inner space of the rotating shaft.

Furthermore, at least one filling material supply or discharge unit may be provided on a side surface of the second waterproof space to discharge the material that has been charged into the second waterproof space from the second waterproof space or supply a material thereinto.

In another aspect, the present invention provides an underwater generator having the underwater electric rotating device, wherein the rotating shaft is oriented in a direction perpendicular to a direction in which water flows, a plurality of support bars are radially provided around the rotating shaft, and a plurality of blades are provided on ends of the support bars in such a way that each of the blades extends a predetermined direction in a direction parallel to the rotating shaft, the blades rotating the rotating shaft using flow of water.

Each of the blades may include: a support blade part connected to the corresponding support bar; at least one variable blade part separately coupled to the support blade part; and a connection member connecting the variable blade part to the support blade part, wherein the variable blade part is able to rotate at least either inwards or outwards based on the support blade part with respect to a direction in which the blade rotates around the rotating shaft.

The blade may be configured such that the size of the blade can be changed by adjusting a distance between the variable blade part and the support blade part.

As described above, the present invention can provide an underwater electric rotating device which can be operated in the underwater environment at low cost using a simple internal waterproofing structure without using a separate complex mechanical structure.

Particularly, the present invention provides a waterproofing structure in which a plurality of waterproof spaces are filled with materials which have different specific gravities or viscosities, wherein the outermost waterproof space into which water may penetrate is filled with a material having higher specific gravity or viscosity than that of water, thus preventing water from entering the device by virtue of a difference in specific gravity or viscosity. Thereby, the present invention can provide the underwater electric rotating device having the waterproofing structure which can provide a reliable waterproofing function despite low production costs.

Moreover, an unharmful environment-friendly material is used as the filling material of each waterproof space, thus preventing a problem of environmental pollution resulting from emission of pollutants, unlike typical mechanical devices.

Furthermore, each waterproof space is filled with fine powder such as nano-powder, liquid containing fine powder or a gel type material so that the difference in specific gravity or viscosity between water and the filling material can be further increased, thus enhancing the effect of preventing water from permeating the device.

In addition, the present invention includes a filling material supply or discharge unit which is used to remove foreign substances that have entered the waterproof space and charge corresponding material into the waterproof space, thus facilitating maintenance and repair of the underwater electric rotating device.

Further, the present invention provides an underwater generator which has a simple waterproofing structure and is able to be directly disposed and operated in water so that the efficiency of generation can be further enhanced. The underwater generator includes a rotating shaft and blades which are perpendicular to the direction of water flow, whereby a contact area between the generator body and water can be minimized despite the structure in which the rotating shaft is directly coupled to the rotor the generator. Moreover, because the generator body is installed to not be exposed to the outside of power generation facilities, the generator can be prevented from being damaged by external force. Furthermore, the maintenance and repair of the generator body can be further facilitated.

Particularly, the underwater generator of the present invention has a vertical shaft blade structure. Therefore, even if only some of the blades are disposed in water because of a small amount of water, the efficiency of generation can be satisfactorily maintained.

### BRIEF DESCRIPTION OF THE DRAWINGS

The above and other objects, features and advantages of the present invention will be more clearly understood from the following detailed description taken in conjunction with the accompanying drawings, in which:

FIG. 1 illustrates a conventional waterproofing structure of an underwater generator using a mechanical seal;

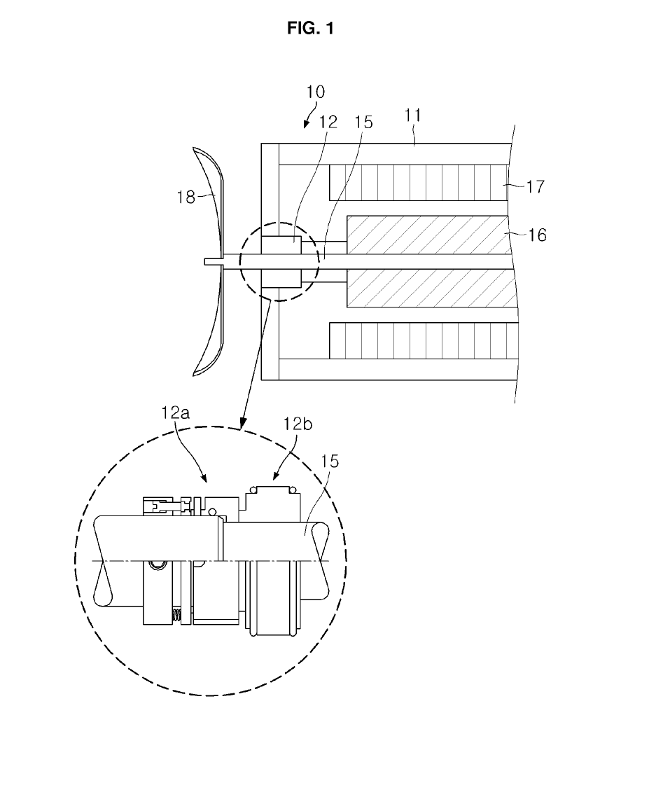

FIG. 2 is a partially broken perspective view of an underwater generator as an embodiment of an underwater electric rotating device according to the present invention;

FIG. 3 is a sectional view of the embodiment of FIG. 2;

FIGS. 4A through 4C illustrate various embodiments of a waterproof space of the underwater electric rotating device according to the present invention;

FIG. 5 illustrates an embodiment of a blade of the underwater electric rotating device according to the present invention;

FIG. 6 illustrates an embodiment of the underwater electric rotating device provided with a filling material supply or discharge unit according to the present invention;

FIG. 7 illustrates an embodiment of an underwater generator provided with a vertical shaft, according to the present invention;

FIG. 8 illustrates another embodiment of an underwater generator provided with a vertical shaft, according to the present invention;

FIGS. 9A and 9B illustrate embodiments of a blade used in the underwater generator according to the present invention;

FIGS. 10A and 10B illustrate an underwater generator provided with a horizontal shaft parallel to a water flow direction, according to the present invention;

FIGS. 11A and 11B illustrate an underwater generator provided with a vertical shaft perpendicular to a water flow direction, according to the present invention; and

FIGS. 12A through 12C show various examples of installation of the vertical shaft type underwater generator according to the present invention.

### DETAILED DESCRIPTION OF THE INVENTION

The present invention provides an underwater electric rotating device which has a plurality of waterproof spaces and provides a waterproof function in such a way that the waterproof spaces are filled with materials having different specific gravities or viscosities, and an underwater generator which can directly generate electricity in the underwater environment using the underwater electric rotating device.

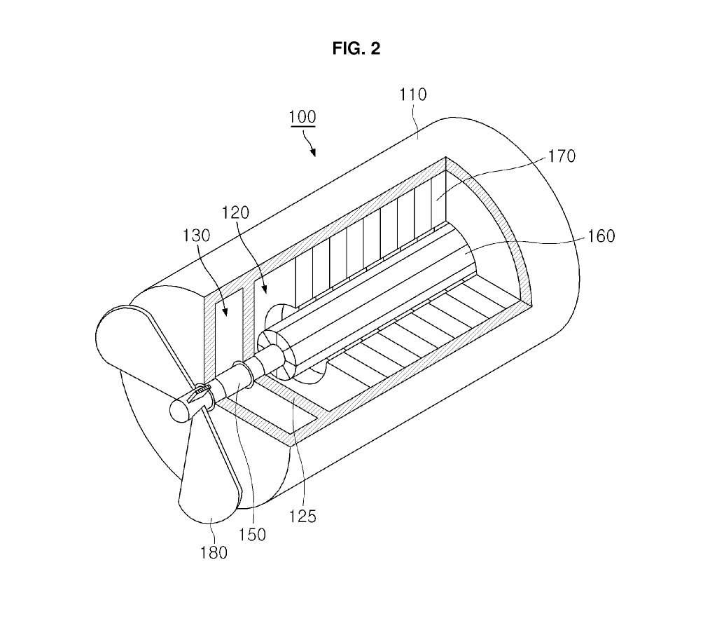

FIG. 2 is a partially broken perspective view of an underwater generator 100 as an embodiment of an underwater electric rotating device according to the present invention.

As shown in FIG. 2, the underwater generator 100 is an underwater electric rotating device which is operated underwater. The underwater generator 100 is provided with a rotor 160 and a stator 170 so as to convert rotational energy into electric energy. The rotor 160 is provided on a rotating shaft 150 such that it can be rotated along with the rotating shaft 150. The stator 170 is provided around the rotor 160 with a predetermined distance between the rotor 160 and the stator 170 and functions to convert induced electromotive force generated by rotation of the rotor 160 into electric energy. Further, in the embodiment of FIG. 2, a first end of the rotating shaft 150 extends out of a housing 110, and blades 180 which are rotated by the flow of water are provided around the first end of the rotating shaft 150.

As such, because the rotating shaft 150 passes through a first end of the housing 110 and extends out of the housing 110, there is the possibility of water entering the housing 110 through the portion at which the rotating shaft 150 passes through the housing 110. In the present invention, a plurality of waterproof spaces are formed in the housing 110 as a waterproofing structure to prevent water from entering the housing 110.

In the embodiment of FIG. 2, a first waterproof space 120 and a second waterproof space 130 are formed in the housing 110 along the rotating shaft 150. The rotor 160 and the stator 170 are disposed in the first waterproof space 120. The second waterproof space 130 is formed along the rotating shaft 150 in such a way that a first side thereof faces the first waterproof space 120 while a second side thereof is brought into contact with external water.

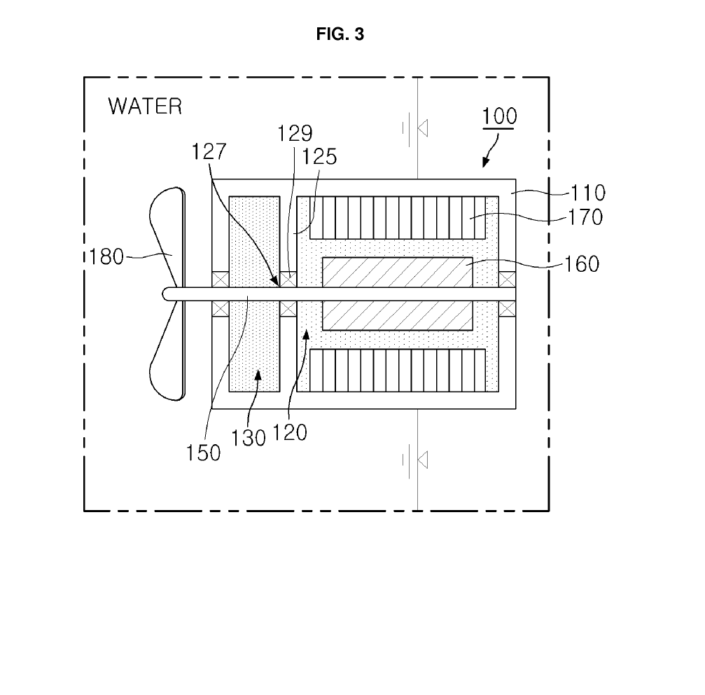

FIG. 3 is a sectional view of the embodiment of FIG. 2. The first waterproof space 120 and the second waterproof space 130 will be described in more detail herein below with reference to FIG. 3.

The first waterproof space 120 and the second waterproof space 130 are separated from each other by a partition wall 125 which is oriented perpendicular to the rotating shaft 150. A through hole 127 in which the rotating shaft 150 is disposed is formed in the partition wall 125. A bearing 129 is provided in the through hole 127 to facilitate rotation of the rotating shaft 150 and prevent penetration of water. As necessary, an additional sealing member may be provided around the through hole 127 so as to further enhance the waterproofing effect.

As shown in FIGS. 2 and 3, the embodiment of the present invention is characterized in that a waterproofing structure is formed in such a way that the first waterproof space 120 and the second waterproof space 130 are respectively filled with materials that are different from each other in specific gravity or viscosity so that penetration of water can be prevented by a difference in specific gravity or viscosity. That is, two kinds of materials that have different specific gravities are layered rather than being mixed with each other because of a difference in specific gravity. As such, the present invention provides the waterproofing structure using the specific gravity difference to prevent penetration of water. Moreover, the present invention provides the structure in which the viscosities of the materials charged into the first and second waterproof spaces 120 and 130 are higher than that of water so that penetration of water is prevented by virtue of high viscosities of the materials. Preferably, the second waterproof space 130 which is brought into contact with water is filled with a material the viscosity of which is much higher than that of water such that water is prevented from entering the second waterproof space 130. The first waterproof space 120 is filled with a material the density of which differs from that of the material charged in the second waterproof space 130. Waterproofing is ensured between the first waterproof space 120 and the second waterproof space 130. Thus, a double waterproofing structure is formed by the first waterproof space 120 and the second waterproof space 130.

In this embodiment, oil the specific gravity of which is higher than that of water is used as the material which is charged into the second waterproof space 130. Engine oil the specific gravity of which is lower than that of water is used as the material which is charged into the first waterproof space 120. More preferably, the filling material contains fine powder to fill the space which is formed between the through hole 127 and the rotating shaft 150 that passes through the through hole 127. For instance, a liquid such as oil, mixed with powder such as nano-powder or silicone powder, may be used as the filling material.

The higher the specific gravity and viscosity of the oil, the more effectively it can prevent water from entering the housing 110. The highest viscosity liquid is mercury. The viscosity of mercury is 13.6 at atmospheric pressure. Various materials having viscosities lower than 13.6 can be used. To effectively prevent penetration of water, a material having viscosity of an extent similar to that of a gel phase material may be used. However, if the first waterproof space 120 is filled with a gel phase material, the rotor 160 may not be easily rotated. Therefore, it is preferable that only the second waterproof space 130 is filled with the material having comparatively high viscosity like the gel phase material.

Furthermore, each waterproof space is filled with an unharmful material, because the filling material may leak out of the housing.

As described above, the present invention can provide an underwater electric rotating device which can be operated in underwater conditions only using a simple internal waterproofing structure at a low cost without requiring a separate complex mechanical structure such as a mechanical seal.

Hereinafter, a preferred embodiment of the present invention will be described in detail to explain the present invention, operational advantages of the present invention and the purpose to be achieved by the embodiment of the present invention.

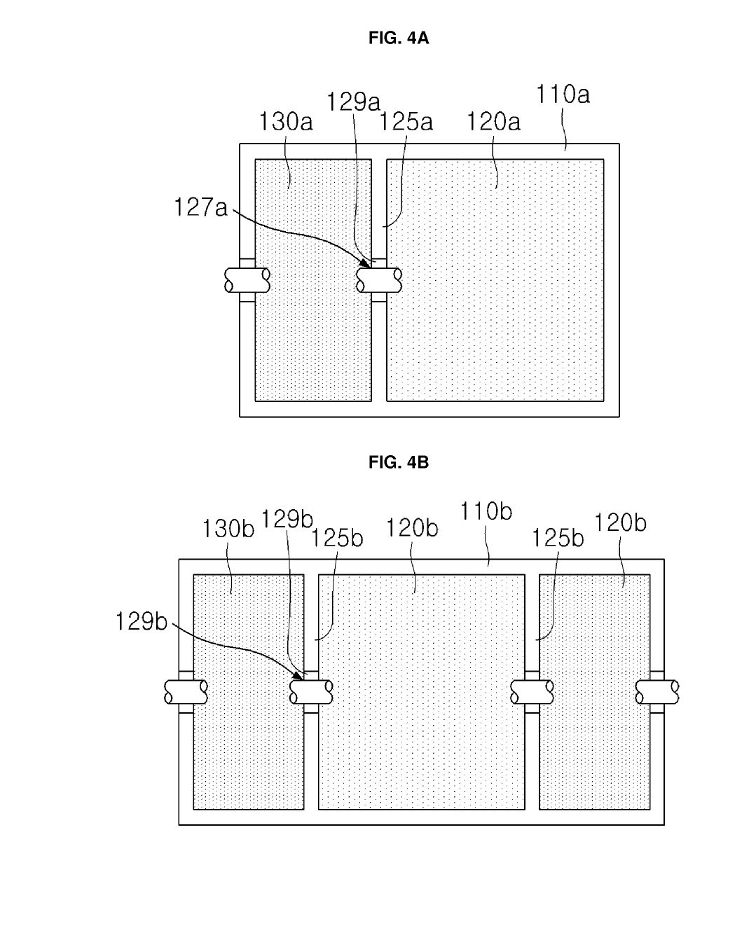

A variety of embodiments of the waterproof space according to the present invention will be described in more detail. FIGS. 4A through 4C illustrate various embodiments of the waterproof space of the underwater electric rotating device according to the present invention.

FIG. 4A shows, as the same structure as the waterproofing structure of FIG. 2, a case where only one side of the underwater electric rotating device is exposed to the underwater environment while the other side thereof is out of water. The general construction of the case of FIG. 4A is the same as that of the embodiment of FIG. 2, therefore further explanation will be omitted.

FIG. 4B illustrates a case where second waterproof spaces 130b are disposed on opposite sides of a first waterproof space 120b that has a rotor and a stator therein.

In FIG. 4B, although the second waterproof spaces 130b disposed on opposite ends of the first waterproof space 120b have been illustrated as being the same and being filled with the same filling material, different waterproof spaces may be disposed on opposite sides of the first waterproof space 120b and filled with respective different materials.

Furthermore, as shown in FIG. 4C, a second waterproof space 130c and a third waterproof space 140c are successively formed from each of both ends of the first waterproof space 120c in a direction away from the first waterproof space 120c along the rotating shaft. The first waterproof space 120c, the second waterproof space 130c and the third waterproof space 140c are filled with materials which are different in specific gravity and viscosity from each other, thus forming a triple waterproofing structure. The waterproof spaces are separated from each other by partition walls 125c and 135c. Through holes 127c and 137c through which the rotating shaft passes are respectively formed in the partition walls 125c and 135c.

Moreover, the underwater electric rotating device according to the present invention is not limited to the embodiments of FIGS. 4A through 4C, and according to the number of waterproof spaces, a variety of multiple waterproofing structures can be provided.

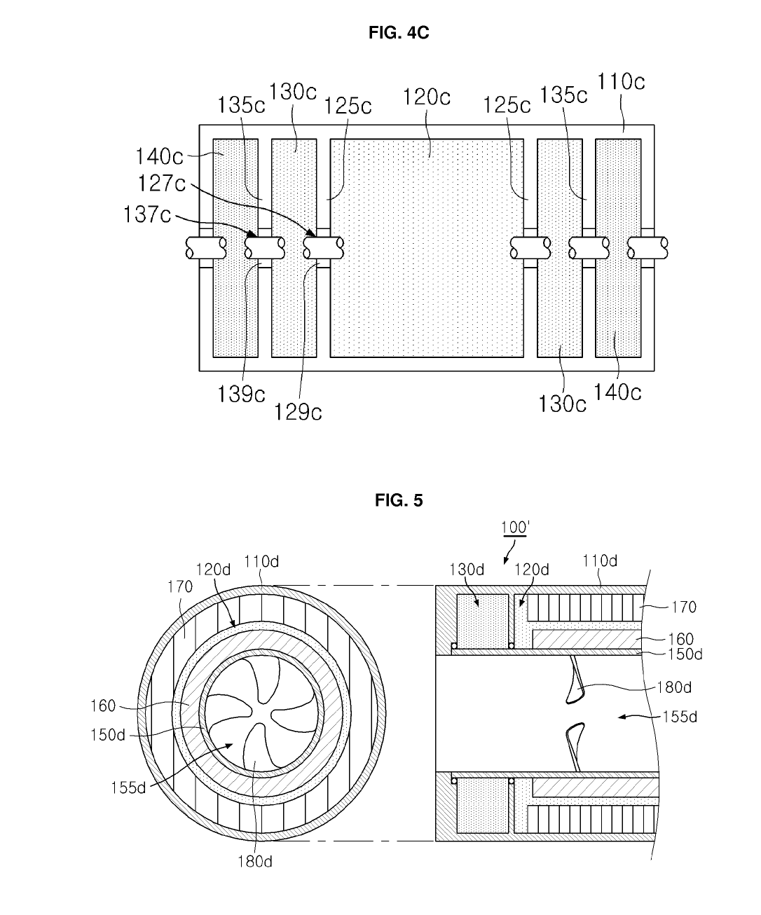

The waterproofing structure for the underwater electric rotating device according to the present invention can be applied to various types of underwater electric rotating devices. As an embodiment of the waterproofing structure, FIG. 5 illustrates one embodiment of a blade of the underwater electric rotating device according to the present invention.

In the underwater electric rotating device 100′ according to the embodiment of FIG. 5, a rotating shaft 150d has a cylindrical pipe structure having a hollow inner space 155d through which water flows. A plurality of blades 180d radially protrudes from a circumferential inner surface of the rotating shaft 150d towards the center axis so that the rotating shaft 150d can be rotated by water which flows through the inner space 155d of the rotating shaft 150d.

In this structure, water may enter the housing 110d through a junction between each end of the rotating shaft 150d and the housing 110d. To prevent this, in this embodiment, as shown in FIG. 5, a second waterproof space 130d is formed in the junction between each end of the rotating shaft 150d and the housing 110d, and a first waterproof space 120d is formed along the rotating shaft 150d between the second waterproof spaces 130d that are disposed on the opposite ends of the rotating shaft 150d. The stator 160 and the rotor 170 are disposed in the first waterproof space 120d. As such, this embodiment forms a double waterproofing structure.

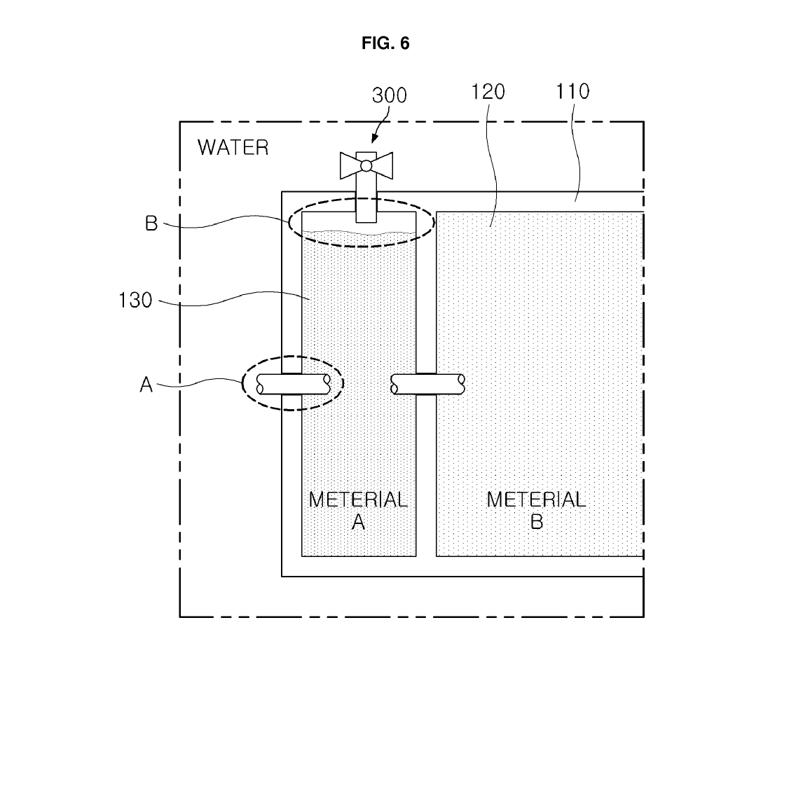

Although the underwater electric rotating device according to the present invention is configured such that a difference in specific gravity or viscosity between water and the filling material prevents water from entering the underwater electric rotating device, the possibility of water entering the underwater electric rotating device may not be completely excluded depending on the circumstances, for example, over a long period of time. However, even if an event in which water enters the underwater electric rotating device occurs, because the present invention has a double or triple waterproofing structure, it is very unlikely that water enters the first waterproof space which is disposed at the innermost position and has the rotor and stator therein, though it may enter the outermost waterproof space. Furthermore, the present invention preferably includes a filling material supply or discharge unit which is used for the maintenance and repair when water enters the outermost waterproof space. FIG. 6 illustrates an embodiment of the filling material supply or discharge unit of the underwater electric rotating device according to the present invention.

The embodiment of FIG. 6 further includes a filling material supply or discharge unit 300 based on the underwater electric rotating device of the embodiment of FIGS. 2 and 3. If water which permeates the second waterproof space 130 through a space A formed around the rotating shaft is accumulated in the second waterproof space 130 for a long period of time, the water forms a layer B on the filling material A provided in the second waterproof space 130 rather than being mixed with the filling material A, because the specific gravity of the filling material A is higher than that of water.

In this embodiment, the water that has been accumulated is discharged through the filling material supply or discharge unit 300 which is provided on an upper portion of the second waterproof space 130, and then an empty space which is formed by the discharge of water is filled again with filling material A. As such, this embodiment makes it possible to maintain the waterproofing function of the underwater electric rotating device. Any one of different kinds of devices can be used as the filling material supply or discharge unit 300, so long as it can be used to discharge water, foreign substances, etc. from the second waterproof space 130. For example, a simple valve structure may be used as the filling material supply or discharge unit 300, and a pump may be removably provided to suck water, foreign substances, etc. out of it.

As described above, the present invention provides the waterproofing structure which has a plurality of waterproof spaces filled with materials which are different in specific gravity or viscosity from each other, so that water can be prevented from entering the underwater electric rotating device by virtue of a difference in specific gravity or viscosity. The waterproofing structure for the underwater electric rotating device according to the present invention can substitute for the conventional mechanical seal or the like which is comparatively expensive. Furthermore, the production cost of the underwater electric rotating device can be reduced, and it is effective in terms of the waterproofing performance.

The waterproofing structure for the underwater electric rotating device according to the present invention having the above-stated construction and effects can be used in an underwater generator, whereby spatial and structural restrictions in installation of the underwater generator can be overcome. Hereinafter, an embodiment of the underwater generator according to the present invention will be described.

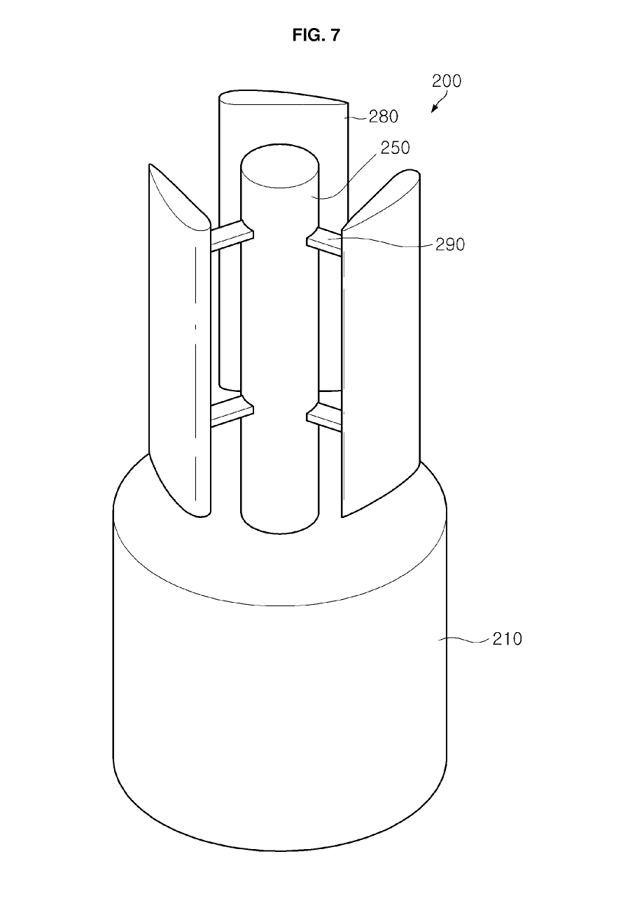

FIG. 7 illustrates an embodiment of an underwater generator provided with a vertical shaft, according to the present invention.

A rotating shaft 250 protrudes from a housing cover 210 of a main body of the generator 200. The generator 200 is disposed such that the rotating shaft 250 is perpendicular to the direction of water flow. A plurality of support bars 290 are horizontally and radially provided around the rotating shaft 250. A plurality of blades 280 are coupled to outer ends of the support bars 290 in such a way that the blades 280 are oriented parallel to the rotating shaft 250. The blades 280 function to rotate the rotating shaft 250 using the flow of water.

Each blade 280 has an airfoil shape such that the rotating shaft 250 provided with the blades 280 can be rotated by flow resistance resulting from the flow of water.

The waterproofing structure of the underwater electric rotating device according to the present invention which has been described with reference to FIGS. 2 through 4 is provided in the housing cover 210 of the main body of the generator 200. The explanation of the waterproofing structure is deemed unnecessary, because it has been illustrated above in detail.

In this vertical shaft type underwater generator 200, the rotating shaft 250 is directly connected to the rotor provided in the main body of the generator 200. Therefore, the rotational motion of the rotating shaft 250 which is generated by the blades 280 can be directly used as a generation energy source rather than being wasted, thus enhancing the generation efficiency. Particularly, given the fact that the main body of the generator 200 is disposed in the underwater environment, the waterproofing structure according to the present invention can make the generation performance more reliable and reduce the production cost of the underwater generator.

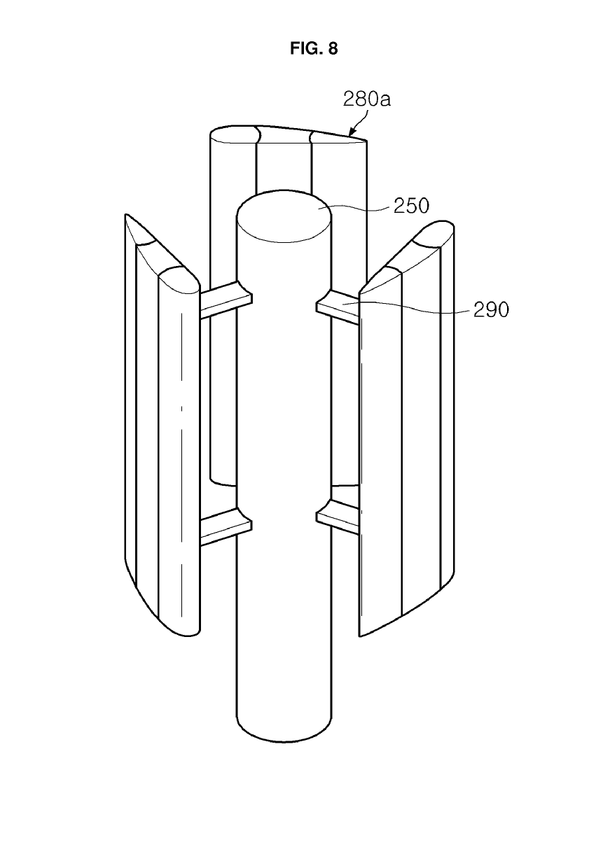

Furthermore, the vertical shaft type underwater generator according to the present invention can use different types of blades to effectively increase the rotational speed of the rotating shaft which is rotated by the flow of water. FIG. 8 illustrates another embodiment of the vertical shaft type underwater generator according to the present invention.

In the same manner as the embodiment of FIG. 7, the embodiment of FIG. 8 also includes a rotating shaft 250 which is vertically disposed, a plurality of support bars 290 which are radially provided around the rotating shaft 250, and blades 280a which are coupled to outer ends of the support bars 290 and oriented parallel to the rotating shaft 250. Unlike the embodiment of FIG. 7, each blade 280a of the embodiment of FIG. 8 is configured such that a variable blade part is coupled to a support blade part. Thus, the blade 280a can be changed in shape depending on the flow of water so that the rotating shaft 250 provided with the blades 280a can be more effectively rotated by the flow of water.

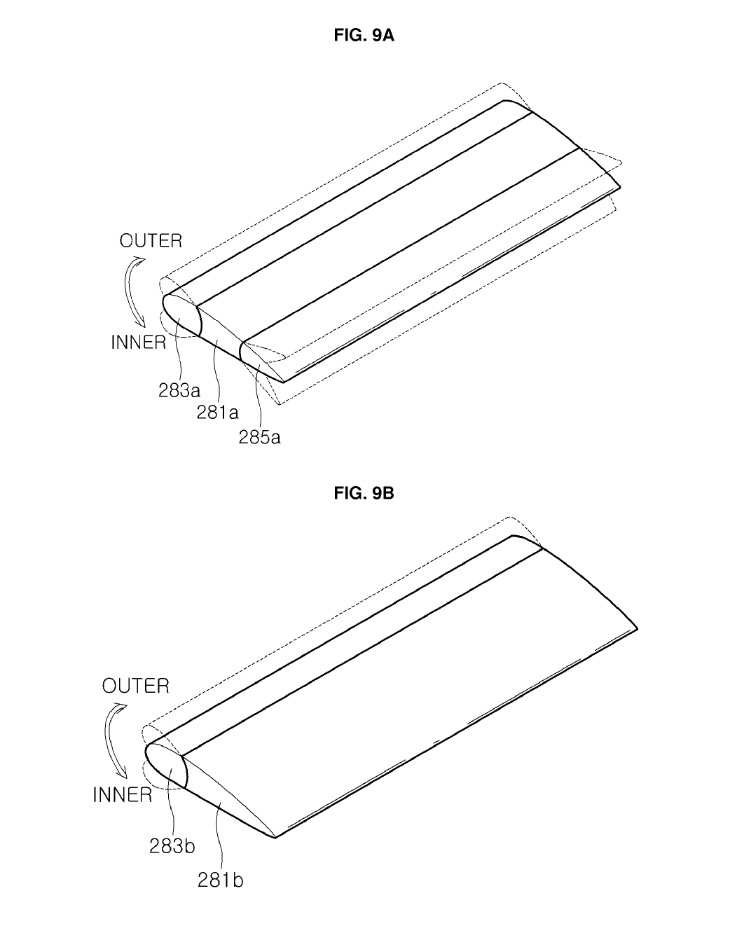

The blade of the embodiment of FIG. 8 will be explained in more detail below. FIGS. 9A and 9B illustrate embodiments of the blade of the underwater generator according to the present invention. FIG. 9A shows the structure of the blade 280a according to the embodiment of FIG. 8.

The blade of FIG. 9A includes a support blade part 281a which is coupled to the corresponding support bar 290, and front and rear variable blade parts 283a and 285a which are separately connected to front and rear sides of the support blade part 281a. The variable blade parts 283a and 285a are connected to the support blade part 281a by connection members (not shown). Here, each connection member is configured such that the corresponding the variable blade part 283a, 285a is supported on the support blade part 281a by the connection member so as to be rotatable on the support blade part 281a within a predetermined angular range. For this, the connection member includes a hinge, a spring or the like to connect the variable blade parts 283a and 285a to the support blade part 281a.

In the embodiment of FIG. 9A, although the single blade has been illustrated as having three blade parts, the present invention is not limited to this embodiment and, e.g., it may include two, four or more blade parts. For instance, in an embodiment of FIG. 9B, the single blade includes two blade parts. A support blade part 281b is connected to the support bar 290, and a variable blade part 283b is connected to one side of the support blade part 281b by a connection member (not shown).

As such, the present invention may use the variable blade configured such that, depending on the speed of the water flow, the radius of curvature of the blade is changed or the length of the blade with respect to the direction in which the blade rotates is changed. In this case, regardless of the speed of water flow, hydroelectric power generation can be continuously and reliably carried out, whereby the generation efficiency can be markedly enhanced. Particularly, the blade is configured such that, when the radius of curvature or the size of the blade is changed, a gap is prevented from being formed in the blade. Hence, flow resistance generated on the blade is minimized, and the rotational force of the rotating shaft with the blades can be sufficiently obtained to conduct hydroelectric power generation.

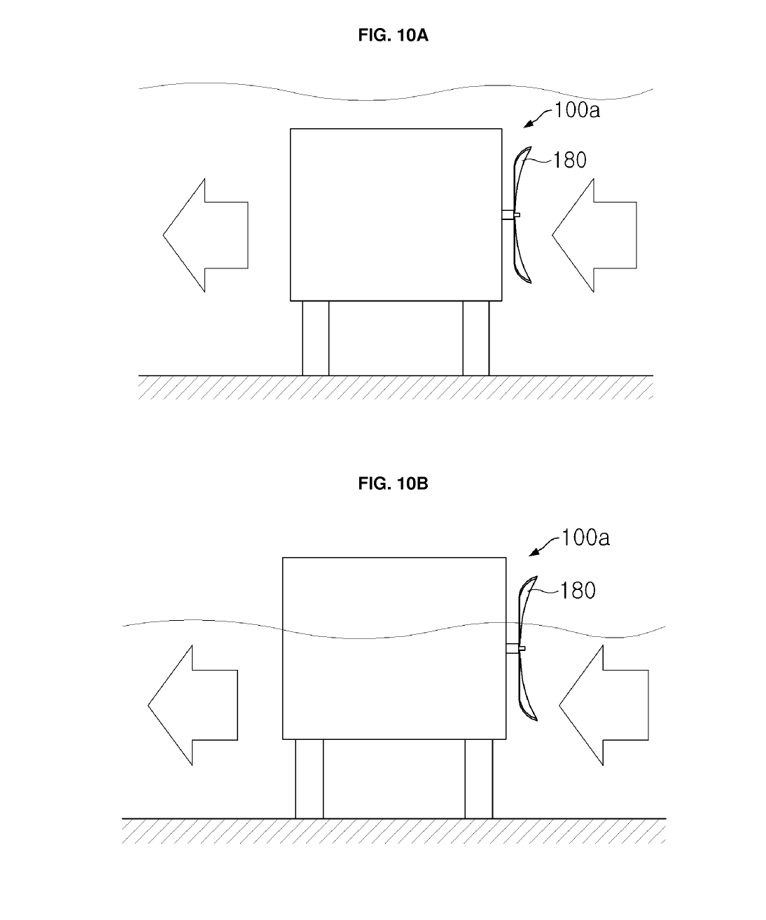

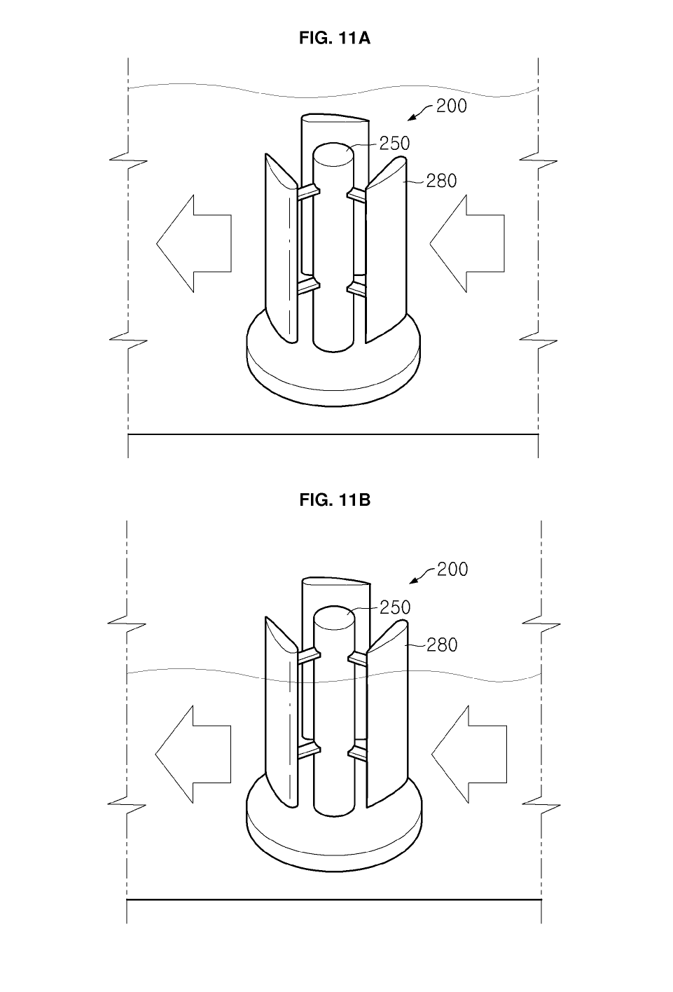

FIGS. 10A, 10B, 11A and 11B illustrate embodiments of the installation of the underwater generator according to the present invention in the underwater environment. FIGS. 10A and 10B illustrate the case of an underwater generator provided with a horizontal shaft parallel to the direction of water flow. FIGS. 11A and 11B illustrate the case of an underwater generator provided with a horizontal shaft parallel to the direction of water flow.

The waterproofing structure according to the present invention makes it possible to directly install the main body 100a of the generator 200 under water at a low cost. Consequently, the efficiency at which the rotational energy of the blades generated by the flow of water is converted into electric energy can be markedly enhanced.

In the case of the underwater generator 100a provided with the horizontal shaft parallel to the direction of water flow, as shown in FIG. 10A, if the amount of water is sufficient to completely immerse the blades, electricity can be effectively generated. However, as shown in FIG. 10B, if only some of the blades 180 are immersed in the water, the blades 180 cannot be smoothly rotated, thus deteriorating the generation performance.

On the other hand, in the case of the vertical shaft type underwater generator 200 of FIGS. 11A and 11B, the blades 280 can be smoothly rotated, as shown in FIG. 11A, not only when there is a sufficient amount of water to completely immerse the blades, but also, as shown in FIG. 11B, when only some parts of the blades are disposed in water, thus making it possible for the underwater generator 200 to be used to generate electricity in a small quantity of water.

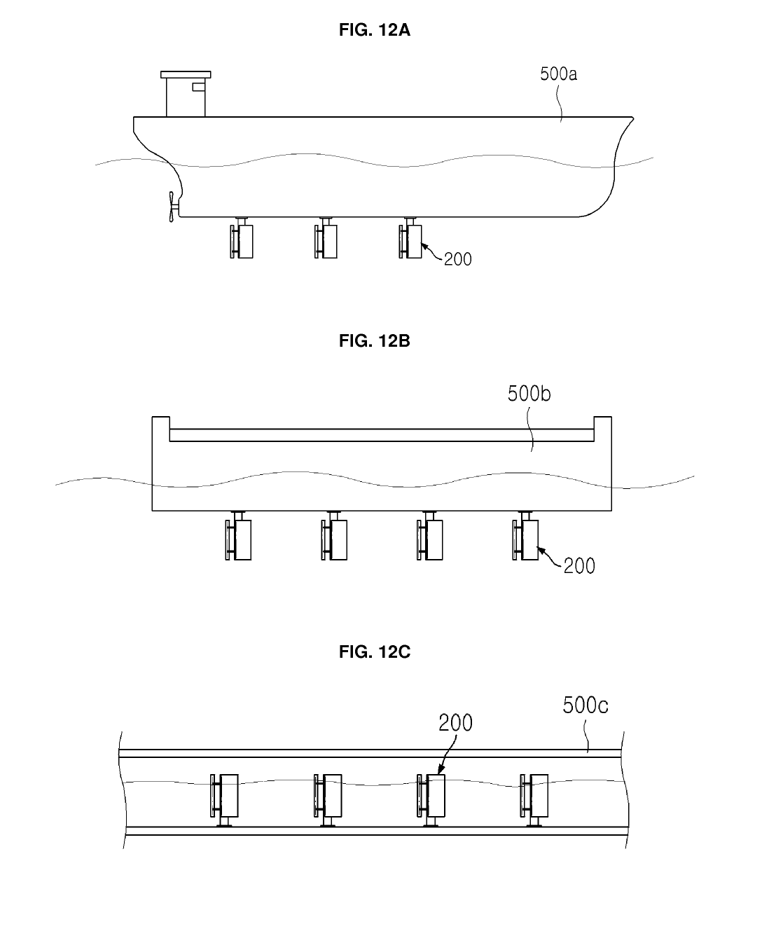

FIGS. 12A through 12C show various examples of installation of the vertical shaft type underwater generator according to the present invention.

FIG. 12A illustrates the case where vertical shaft type underwater generators 200 are installed under a ship 500a which is on the sea or a river. The underwater generators 200 which are installed under the ship 500a can generate electricity using the flow of water in the sea or river. Moreover, when the ship 500a is moving, the speed of the water flow is further increased, whereby the generation of electricity using the vertical shaft type underwater generators 200 is further effective.

FIG. 12B illustrates the case where vertical shaft type underwater generators 200 are installed under a structure 500b such as a bridge which is constructed on the sea or river. FIG. 12C illustrates the case where vertical shaft type underwater generators 200 are installed in a pipe 500c such as a water service pipe or a sewer pipe.

As described above, an underwater generator according to the present invention can be unrestrictedly directly installed in a wide variety of underwater environments. Furthermore, in the case where the underwater generator is provided with a vertical shaft, there are no spatial restrictions in installation of the generator, and maintenance and repair of the generator can be further facilitated.

While the preferred embodiments of the present invention have been disclosed for illustrative purposes, the present invention is not limited to the embodiments or drawings disclosed in this specification, and those skilled in the art will appreciate that various modifications, additions and substitutions are possible. Therefore, the scope of the invention must be defined by the appended claims and equivalents of the claims rather than by the description preceding them.

1. An underwater electric rotating device having a waterproofing structure, comprising:
a rotating shaft, at least a portion of which is rotated in an underwater environment;
a rotor provided around a portion of an outer surface of the rotating shaft, the rotor being rotated along with the rotating shaft;
a stator provided around the rotor at a position corresponding to the rotor with a predetermined distance between the rotor and the stator, the stator rotating the rotor using electric energy or generating electric energy using rotation of the rotor; and
a housing having at least two waterproof spaces successively formed therein in a direction of the rotating shaft, the at least two waterproof spaces being separated from each other by a partition wall formed perpendicular to the rotating shaft, with a through hole formed in the partition wall so that the rotating shaft is disposed in the through hole so as to be rotatable,
wherein, in the at least two waterproof spaces, a waterproof space that is disposed at an outermost position based on a waterproof space having the rotor and the stator therein is filled with a material that is higher in specific gravity or viscosity than water at room temperature under atmospheric pressure.

2. The underwater electric rotating device as set forth in claim 1, wherein the at least two waterproof spaces of the housing comprise:
a first waterproof space having the rotor and the stator therein; and
two second waterproof spaces respectively provided on opposite ends of the first waterproof space,
wherein the first waterproof space is filled with a material that is lower in specific gravity or viscosity than a material charged into the second waterproof space.

3. The underwater electric rotating device as set forth in claim 1, wherein the at least two waterproof spaces of the housing comprise:
a first waterproof space having the rotor and the stator therein; and
a second waterproof space configured such that a first side thereof faces the first waterproof space while a second side thereof comes into contact with water,
wherein the first waterproof space is filled with a material that is lower in specific gravity or viscosity than a material charged into the second waterproof space.

4. The underwater electric rotating device as set forth in claim 2, wherein the material charged into the first waterproof space is lower in specific gravity or viscosity than the water, and
the material charged into the second waterproof space is higher in specific gravity or viscosity than the water.

5. The underwater electric rotating device as set forth in claim 2, wherein a bearing or seal is provided in the through hole around the rotating shaft to facilitate the rotation of the rotating shaft.

6. The underwater electric rotating device as set forth in claim 1, wherein the material charging into each of the waterproof spaces comprises a liquid containing powder or a gel-type liquid.

7. The underwater electric rotating device as set forth in claim 1, wherein an end of the rotating shaft is disposed in water, and a plurality of blades are radially provided around the end of the rotating shaft so that the rotating shaft is rotated by flow of water.

8. The underwater electric rotating device as set forth in claim 1, wherein the rotating shaft comprises a cylindrical pipe structure having a hollow inner space through which water flows, and
a plurality of blades protrude from an inner surface of the rotating shaft towards a center axis thereof so that the rotating shaft is rotated by water flowing through the hollow inner space of the rotating shaft.

9. The underwater electric rotating device as set forth in claim 2, wherein at least one filling material supply or discharge unit is provided on a side surface of the second waterproof space to discharge the material that has been charged into the second waterproof space from the second waterproof space or supply a material thereinto.

10. An underwater generator having the underwater electric rotating device as set forth in claim 1, wherein
the rotating shaft is oriented in a direction perpendicular to a direction in which water flows,
a plurality of support bars are radially provided around the rotating shaft, and
a plurality of blades are provided on ends of the support bars in such a way that each of the blades extends a predetermined direction in a direction parallel to the rotating shaft, the blades rotating the rotating shaft using flow of water.

11. The underwater generator as set forth in claim 10, wherein each of the blades comprises: a support blade part connected to the corresponding support bar; at least one variable blade part separately coupled to the support blade part; and a connection member connecting the variable blade part to the support blade part,
wherein the variable blade part is able to rotate at least either inwards or outwards based on the support blade part with respect to a direction in which the blade rotates around the rotating shaft.

12. The underwater generator as set forth in claim 11, wherein the blade is configured such that a size of the blade can be changed by adjusting a distance between the variable blade part and the support blade part.

13. The underwater electric rotating device as set forth in claim 3, wherein the material charged into the first waterproof space is lower in specific gravity or viscosity than the water, and
the material charged into the second waterproof space is higher in specific gravity or viscosity than the water.

14. The underwater electric rotating device as set forth in claim 3, wherein a bearing or seal is provided in the through hole around the rotating shaft to facilitate the rotation of the rotating shaft.

15. The underwater electric rotating device as set forth in claim 3, wherein at least one filling material supply or discharge unit is provided on a side surface of the second waterproof space to discharge the material that has been charged into the second waterproof space from the second waterproof space or supply a material thereinto.
